(19) United States
(12) Patent Application Publication
(10) Pub. No.: US 2018/0117752 A1
(43) Pub. Date: May 3, 2018

(54) MULTI-USE PRY BAR

(71) Applicant: JPW Industries Inc., La Vergne, TN (US)

(72) Inventors: Charles Weber, Onalaska, WI (US); Thomas Balko, La Crosse, WI (US); Benjamin Carlson, Holmen, WI (US); Joseph Galluzzi, Nashville, TN (US); Adam Brown, Nolensville, TN (US)

(73) Assignee: JPW Industries Inc., La Vergne, TN (US)

(21) Appl. No.: 15/791,983

(22) Filed: Oct. 24, 2017

Related U.S. Application Data
(60) Provisional application No. 62/489,810, filed on Apr. 25, 2017.
(60) Provisional application No. 62/413,806, filed on Oct. 27, 2016.

(51) Int. Cl. B25F 1/02; B25F 1/00; B25G 3/02; B66F 15/00

(52) U.S. Cl. CPC B25F 1/02; B66F 15/00; B25G 3/02; B25F 1/006

(57) ABSTRACT

A pry bar has an elongated body with a coupler and a striking face at opposite ends. The coupler includes a receiver opening to receive a mounting end of a replaceable head. The coupler is operable to lock or unlock the replaceable head in the elongated body. The coupler may include a broached sleeve having ball bearings in radial openings that may be moved into engagement with the mounting end of the replaceable head. A movable sleeve is mounted on the broached sleeve to engage the ball bearings as the movable sleeve is moved. A spring on the broached sleeve urges the movable sleeve to the locked position. A retainer collar on the broached sleeve keeps the movable sleeve on the broached sleeve. A coupler may instead have a threaded collar for operating a collet sleeve. A set of replaceable heads may be provided.

### CROSS REFERENCE TO RELATED APPLICATIONS

The present application claims the benefit of U.S. Provisional Patent Application No. 62/413,806 filed Oct. 27, 2016, and U.S. Provisional Patent Application No. 62/489,810 filed Apr. 25, 2017, each of which is incorporated herein by reference.

### BACKGROUND

### Field

The present disclosure relates generally to a pry bar, and more particularly to a method and apparatus for changing heads on a pry bar, as well as to a system including a pry bar and a plurality of interchangeable heads.

### Related Art

Pry bars are used for various projects including removing roofing and floor tiles, lifting, separating or loosening or other work as is well known.

### SUMMARY

The present disclosure provides a pry bar that is configured to accept an interchangeable head. The pry bar includes an elongated body that may include a striking face, handle, or other feature at an end of the body. A collet or chuck is provided at an opposite end of the elongated body. A head is removably attached in the collet or chuck. The collet or chuck may be loosened or unlocked and the head changed to another head of the same or a different type.

The collet or chuck of certain embodiments can include a movable sleeve configured to be moved between a locked position and an unlocked position to selectively secure, fasten, or affix the interchangeable head to the elongated body of the pry bar. In the unlocked position of the sleeve, the collet or chuck is loosened or unlocked and the head can be inserted into the collet or chuck or the head can be removed from the collet or chuck and another head inserted in its place. When the sleeve is moved to the locked position, the collet or chuck secures, fastens, or otherwise affixes a head within the collet or chuck. When the sleeve is in the locked position, the head in the collet or chuck is secured or fastened in a fixed position in the collet or chuck. The sleeve provides a tool-less operation of the collet or chuck. Other tool-less configurations are also possible for tightening or loosening the collet or chuck.

In some embodiments, the collet or chuck is tighten or loosen using a spanner wrench or crescent wrench instead of via use of a sleeve as in the above tool-less embodiment. Other tools such as wrenches, chuck keys or the like may be provided to tighten or loosen the collet or chuck.

When the collet or chuck is in the unlocked or loosened condition, the head can be removed and replaced with another head, such as a head of a different shape or intended for a different task. The collet or chuck may be tightened or locked so that the different head is affixed to the pry bar for performing work.

Each head may be provided with an extension that is configured to fit into the collet or chuck. The extension can be shaped as, for example, an elongated hexagonal prism, a cylinder, a rectangular prism, or another shape as would be understood by those skilled in the art. The extension may be securely fastened therein by tightening or locking the collet or chuck such as by moving the movable sleeve into the locked position for the tool-less embodiments or by using the a tool in the other embodiments. The head may be removed from the collet or chuck by unlocking or loosening the collet or chuck by moving the movable sleeve into the unlocked position or by use of a tool. A single pry bar handle may be used with any of a plurality of heads.

In the tool-less embodiments, the sleeve at the collet or chuck, may for example also serve to protect the collet or chuck from damage during use of the pry bar. In the tool-operated embodiments, the sleeve may optionally be provided to provide protection for the collet or chuck.

A striking surface may be provided at the end of the pry bar opposite the collet or chuck and/or at other locations on the pry bar. The striking surface may be provided by shaping the end of the pry bar, by permanently affixing a striking member to the pry bar, or by a removably affixing a striking member to the pry bar.

The present disclosure may also provide a plurality of heads configured for mounting in a collet or chuck. The heads may include wheels, kick plates, rockers, points, wedges, rounds, pinch, chisels, heeled pinches, paddles, and/or any other shapes and configurations for working heads of pry bars or the like.

### BRIEF DESCRIPTION OF THE DRAWINGS

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 is side perspective view of a pry bar according to an exemplary embodiment of the present disclosure.

FIG. 2 is a side perspective view of a portion of the pry bar showing the collet or chuck assembly according to an exemplary embodiment of the present disclosure.

FIG. 3 is an exploded side perspective view of a portion of the pry bar showing the collet or chuck assembly according to an exemplary embodiment of the present disclosure.

FIG. 4 is a cross-sectional view of a collet or chuck assembly in a locked position taken along the axis of the pry bar according to an exemplary embodiment of the present disclosure.

FIG. 5 is a cross-sectional view of the collet or chuck assembly as shown in FIG. 4 in an unlocked position.

FIG. 6 is an end perspective view of a pry bar according to an exemplary embodiment of the present disclosure.

FIG. 7 is a close-up end view of a pry bar according to an exemplary embodiment of the present disclosure.

FIG. 8 is a presentation sheet showing an embodiment of a pry bar with a plurality of optional components including a set of interchangeable heads according to exemplary embodiments of the present disclosure.

FIG. 9 is a plan view of a plurality of heads for fastening into the collet of the pry bar according to exemplary embodiments of the present disclosure. The heads include a right angle chisel head, a shallow angle chisel head, a round point head, a small jointed socket fitting, and a large jointed socket fitting shown from right to left.

FIG. 10 is a side perspective view of a second embodiment of the pry bar.

FIG. 11 is a top perspective view of a collet or chuck of the second embodiment.

FIG. 12 is a top perspective view of a tool affixing a head in the collet or chuck of the second embodiment.

FIG. 13 is a top perspective view of a striking end of the pry bar of the second embodiment.

FIG. 14 is a side perspective view of a third embodiment of the pry bar.

FIG. 15 is an exploded view of the coupler of the third embodiment.

FIG. 16 is an enlarged side view, partially broken, of the third embodiment.

FIG. 17 is a cross-sectional view of the third embodiment.

FIG. 18 is a perspective view of the coupler mounted on the elongated body of the third embodiment.

FIG. 19 is a perspective view of the broached sleeve of the third embodiment.

FIG. 20 is a side view of the broached sleeve of the third embodiment.

FIG. 21 is a axial cross-sectional view of the broached sleeve of the third embodiment.

FIG. 22A is an end view of the broached sleeve of the third embodiment.

FIG. 22B is a transverse cross sectional view of the broached sleeve showing the shaped openings for receiving the ball bearings.

FIG. 23 is a perspective view of the movable sleeve of the third embodiment.

FIG. 24 is a side view of the movable sleeve of the third embodiment.

FIG. 25 is a cross-sectional view of the third embodiment.

FIG. 26 is a perspective view of the spring of the third embodiment.

FIG. 27 is an end view of a washer of the third embodiment.

FIG. 28 is an end view of a clamp ring of the third embodiment.

FIG. 29 is an exploded view of a handle of the third embodiment.

FIG. 30 is a side view of the handle end of the elongated embodiment of the third embodiment.

FIG. 31 is an end view of the handle end of the elongated embodiment of the third embodiment.

FIG. 32 is a perspective view of a handle member of the third embodiment.

FIG. 33 is a perspective view of a spiral pin of the third embodiment.

FIG. 34 is a perspective view of a straight chisel head of the third embodiment.

FIG. 35 is a perspective view of an angled chisel head of the third embodiment.

FIG. 36 is a perspective view of a right angle head of the third embodiment.

FIG. 37 is a perspective view of a point head of the third embodiment.

FIG. 38 is an exploded view of a driver head of the third embodiment.

FIG. 39 is a perspective view of a shaft of the driver head of the third embodiment.

FIG. 40 is a perspective view of a small driver for the driver head of the third embodiment.

FIG. 41 is a perspective view of a large driver for the driver head of the third embodiment.

The exemplary embodiments of the present disclosure will be described with reference to the accompanying drawings.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

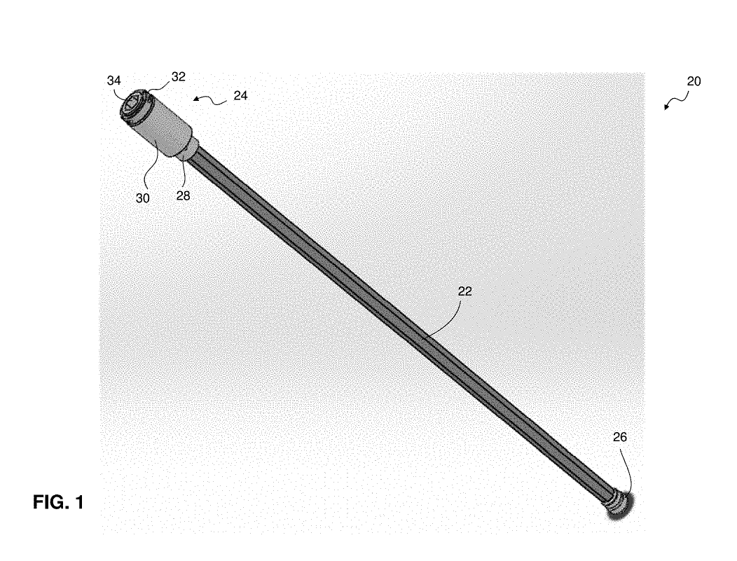

As illustrated in FIG. 1, a pry bar 20 includes an elongated body 22 at one end of which is provided a collet, chuck or other coupler or attachment device 24 that is configured to accept any of several different attachable heads, and at the other end of which is a striking face or handle 26. By exchanging the heads on the pry bar 20, the pry bar 20 can replace multiple separate pry bars or other tools each with a different head or use. For ease of discussion, the collet, chuck or other coupler or attachment device 24 will be referred hereinafter as the coupler 24. The coupler 24 may be configured as a collet, as a chuck, as a ball bearing or other radial element connector, as a bayonet connector, as a threaded connector, as a pin connector, button connector, or other attaching or coupling device. The coupler 24 can include a broached sleeve 28 mounted on the elongated body 22, a movable sleeve 30 mounted for movement in an axial direction of the elongated body 22, and a retaining collar 32 at an end of the coupler 24. The coupler 24 includes an end opening or receiver 34 into which mounting portions of a head may be inserted. In an exemplary embodiment, the movable sleeve 30 is configured to slidably move along the broached sleeve 28 between a locked position and an unlocked position. The movable sleeve 30 is shown in the locked position in FIG. 1. The toolless operation of the coupler may be provided by a button, latch or other mechanism instead of or in addition to the movable sleeve.

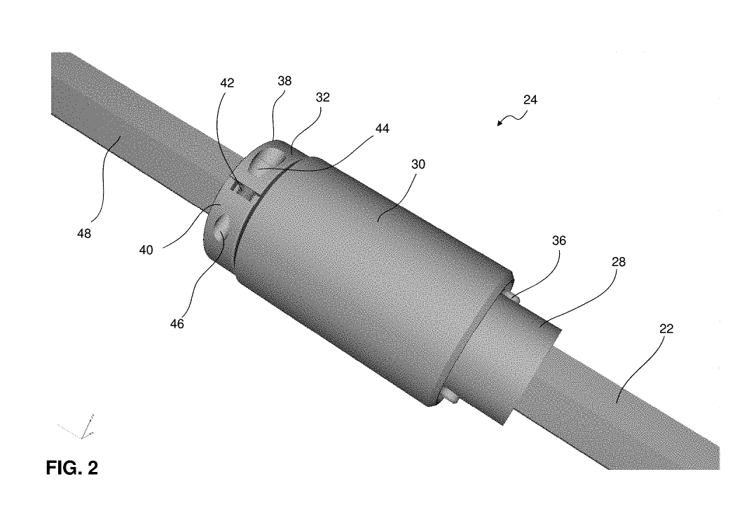

In FIG. 2 is shown an enlarged view of the coupler 24 according to an exemplary embodiment of the present disclosure. The illustrated coupler 24 includes the broached sleeve 28 which is mounted at the end of the elongated body 22. The elongated body 22 may be formed of a hexagonal bar as shown in the drawing or may be of a cylindrical bar or other shape as desired. The elongated body may be formed of steel or other material. The broached sleeve 28 may be affixed to the elongated body 22 by any of a variety of different fastening means including by welding, screws, bolts, rivets, crimping, or the like. In the illustration, a dowel pin 36 extends through a transverse opening in the elongated body 22 and through openings in the broached sleeve 28. The dowel pin 36 attaches the broached sleeve 28 to the elongated body 22 The dowel pin 36 may be fastened in the elongated body 22 and the broached sleeve 28 by welding, adhesive, friction fit, threading, deformation or other attachment means. The broached sleeve 28 includes a cylindrical outer surface in the illustrated embodiment, although other shapes are possible. The interior surface of the broached sleeve 28 may be of a shape corresponding to the shape of the elongated body, such as of a hexagonal shape to receive the elongated body 22. The movable sleeve 30 is of a larger diameter than the broached sleeve 28 and is mounted over at least a portion of the broached sleeve 28. The outer surface of the movable sleeve may be smooth as shown or may be provided with a grip enhancing surface by as by a knurled, contoured or textured surface, a coating, a grip sleeve, or other grip enhancement. The movable sleeve 30 is shown in the locked position adjacent to and/or bearing against the retaining collar 32. The retaining collar 32 is formed of first and second collar parts 38 and 40 that are attached to one another by a threaded screw 42 extending between the two collar parts 38 and 40. In the example the screw 42 is seated in a stepped bore 44 in the first collar part 38 and threadably engages a threaded bore 46 in the second collar part 40, which bores 44 and 46 extend transverse of the elongated body 22. The screw 42 may be rotated in the stepped bore 44 so that the threaded movement of the screw in the threaded bore 46 tightens or loosens the retaining collar 32. A replaceable head 48 is shown mounted in the coupler 24 in FIG. 2.

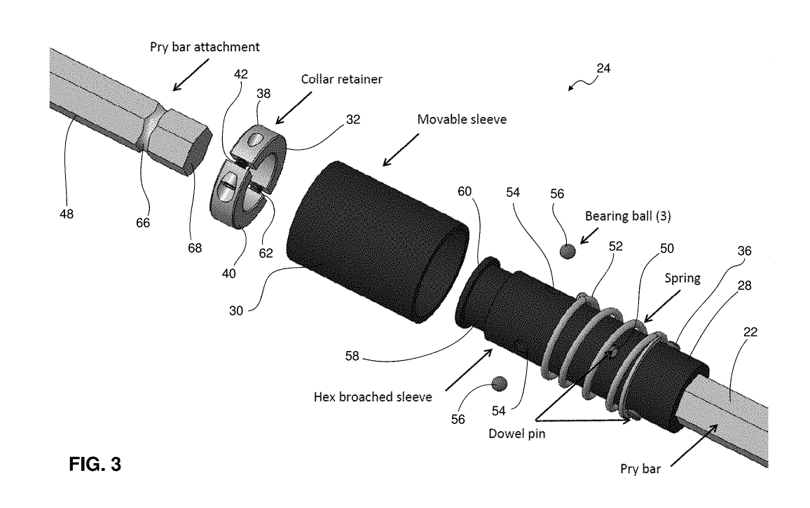

FIG. 3 is an exploded view of the coupler 24 according to an exemplary embodiment of the present disclosure. The broached sleeve 28 is mounted on the elongated body 22 by dowels, a first dowel 36 having been described with reference to FIG. 2. A second dowel 50 extends through an opening in the elongated body 22 and through openings in the broached sleeve 28 and is secured in place by a fastening or retaining means, such as threading, welding or adhesive. The second dowel 50 also fastens the broached sleeve 28 to the elongated body 22. More or fewer dowels may be provided. The broached sleeve may be attached to the elongated body 22 by other means or may be formed integrally therewith. The first dowel 36 and second dowel are spaced from one another in an axial direction of the elongated body 22 and extend in transverse directions relative to one another. Other arrangements of the dowels are possible. The first dowel 36 may extend beyond the surface of the broached sleeve 28 at one or both ends to provide a stop for a spring 52. The spring 52 of the illustrated embodiment is a coil spring disposed around the broached sleeve 28. As the spring is flexed, the ends of the first dowel 36 prevent the spring from moving off the broached sleeve 28. The ends of the second dowel 50 may be flush with the surface of the broached sleeve 28 or may be recessed below the surface of the broached sleeve 28 to permit the spring 52 to move over the ends of the second dowel 50 as the spring is flexed. In an exemplary embodiment, the movable sleeve 30 is biased to towards the retaining collar 32 by the spring 52. When the coupler is assembled, the movable sleeve 30 is coaxially positioned on the broached sleeve 28 and the spring 52 and engages the distal end of the spring 52 (to the left in this view). The spring 52 is positioned coaxial with and along the broached sleeve 28 and can be retained on or secured to the broached sleeve 28 by one or more the dowel pins 36 and 50 that also serve to secure the broached sleeve 28 to the elongated body 22. The proximal end of the spring 52 (to the right in this view) is engaged by the ends of the first dowel 36. In operation, the spring 52 may be held in place along the broached sleeve 28 and exerts spring force against the dowel pin 36 and the movable sleeve 30 due to the biasing force generated by the spring 52.

The broached sleeve 28 may be provided with one or more openings 54. In the illustrated embodiment, three openings 54 are provided in the broached sleeve 28. The openings 54 may be evenly spaced around the circumference of the broached sleeve 28 at a single axial position along the broached sleeve 28. More or fewer openings may be provided within the scope of the invention. Each of the openings 54 is provided with a ball bearing 56 in the illustrated embodiment. More or fewer ball bearings 56 may be provided. The ball bearings 56 are provided in respective ones of the openings 54. The openings 54 extend from the exterior of the broached sleeve 28 to an interior of the broached sleeve 28. The ball bearings 56 may move within the openings 54 in a radial direction relative to the pry bar to engage a removable head inserted into the coupler 24. The ball bearings 56 are an example of radially movable locking members. Although ball bearings are shown in the illustrations, the radially movable locking members may be pins or other movable fasteners or structures to secure the head in the coupling. The movable sleeve 30 may control the movement of the ball bearings 56 in the openings 54.

The broached sleeve 28 of the illustrated embodiment includes a channel 58 extending radially inward of the broached sleeve 28. A flange 60 extends radially outward at a distal end of the broached sleeve 28. The channel 58 is of a shape and size to accept the retaining collar 32. The flange 60 holds the retaining collar 32 in place and prevents the retaining collar 32 from slipping off the end of the broached sleeve 28. The retaining collar 32 retains the movable sleeve 30 on the broached sleeve 28.

In the exploded view of FIG. 3 can be seen the two collar parts 38 and 40 which are fastened to one another by the threaded screw 42 and by a second threaded screw 62. The screws 42 and 62 may be tightened to secure the retaining collar 32 in the channel 58. The threaded screws 42 and 62 may be set screws in the illustrated embodiment which operate to move the first and second collar parts 38 and 40 closer together to secure the collar 32 in the channel 58 or may be loosened for removal of the collar 32 and disassembly of the coupler 24.

A removable head 48 is shown; more specifically, a mounting shaft 64 of a removable head 48. The mounting shaft 64 is of a hexagonal cylinder shape in the illustrated embodiment and fits into a correspondingly sized and shaped opening in the coupler 24. The hexagonal shape of the mounting shaft 64 prevents rotation of the removable head in the coupler 24. The mounting shaft 64 includes a circumferential channel 66 spaced by a predetermined distance from an end 68 of the removable head 48. The circumferential channel 66 receives the ball bearings 56 when the end 68 is inserted into the coupler 24. The circumferential channel 66 of the illustrated embodiment has a rounded or curved bottom in the channel 66 to receive the round ball bearings 56. The radius of the rounded circumferential channel 66 may correspond to the radius of the ball bearings 56 in certain embodiments.

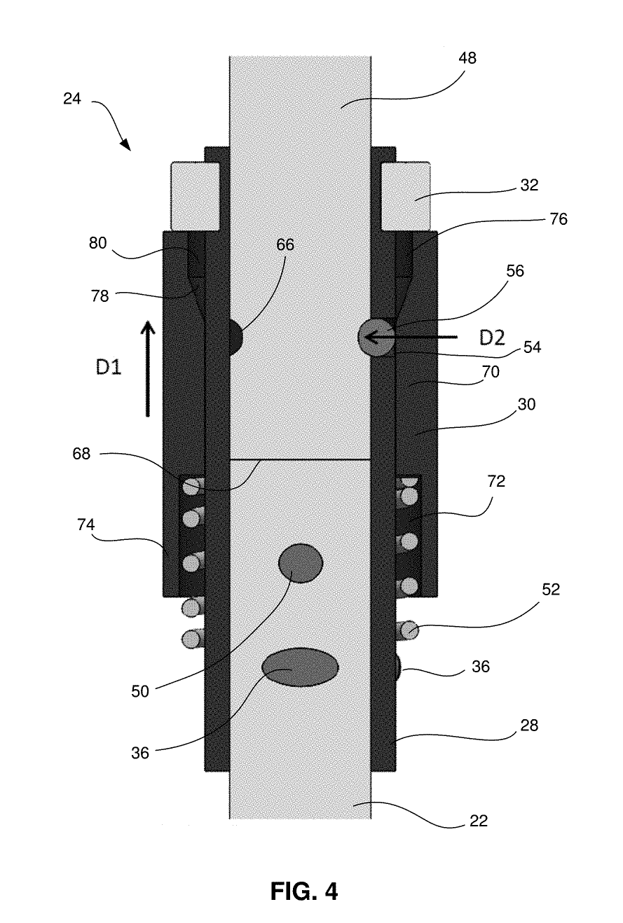

FIG. 4 shows a cross-sectional view of the coupler 24 in a locked position with the replaceable head 48 locked in the coupler 24. The replaceable head 48 has been inserted into the coupler 24 to a depth where the ball bearing 56 is seated in the circumferential channel 66. In the illustration, the end 68 of the replaceable head 48 is seated against or closely proximate to an end of the elongated body 22 within the coupler 24. The positioning of the end 68 against the end surface of the elongated body 22 locates the circumferential channel 66 at the openings 54 in the broached sleeve 28 and in a position to receive the ball bearings 56. The movable sleeve 30 is in a lock position bearing against the retainer collar 32. The movable sleeve 30 is maintained in the lock position by the force of the spring 52 pressing the movable sleeve 30 in a direction D1 as indicated by the arrow. The movable sleeve 30 has a shaped interior surface which includes a thick portion 70 that has an inner surface that is closely proximate to the outer surface of the broached sleeve 28. The thick portion 70 may contact the exterior of the broached sleeve 28 or may be spaced from the exterior surface of the broached sleeve 28. The thick portion 70 is in contact with the ball bearing 56 to maintain the ball bearing 56 in the circumferential channel 66 in the replaceable head 48. With the thick portion of the movable sleeve bearing against the ball bearing 56, the replaceable head 48 may not be removed from the coupler 24. In certain embodiments, three of the ball bearings 56 are seated in the circumferential channel 66 at generally equal spacing about the replaceable head 48 to ensure that the head is held securely in the coupler 24.

The movable sleeve 30 includes an internal recess 72 into which the spring 52 is received. The movable sleeve 30 includes a skirt 74 that extends over the spring 52. The skirt 74 may extend over a portion of the spring 52 or over the full length of the spring 52, as desired. In the illustrated embodiment, the skirt 74 covers the second dowel 50 but the first dowel 36 and the proximal end of the spring 52 are not covered by the skirt 74 in the locked position. The first dowel 36 extends at an angle to the plane of the cross-sectional view, resulting in the cross section of the dowel 36 appearing as an oval.

The movable sleeve 30 includes an unlock/lock recess 76 having a ramp section 78 extending from the thick portion 70 and an unlock section 80 adjoining the ramp section 78. The movable sleeve 30 is movable axially along the broached sleeve 28 in a direction away from the retaining collar 32, which results in the ball bearings 56 moving into the unlock/lock recess 76. When the movable sleeve 30 has been moved a distance sufficient that the ball bearings 56 may move into the unlock section 80, pulling force on the replaceable head 48 may move the ball bearings from the circumferential channel 66 and into the openings 56 and the unlock section 80 so that the replaceable head 48 may be removed from the coupler 24.

The openings 54 within which the ball bearings 56 are mounted preferably include a taper or constriction at the inside surface of the broached sleeve 28 to prevent the ball bearings from passing entirely through the openings 54 and into the interior of the broached sleeve 28 when the replaceable head 48 is removed from the broached sleeve 28.

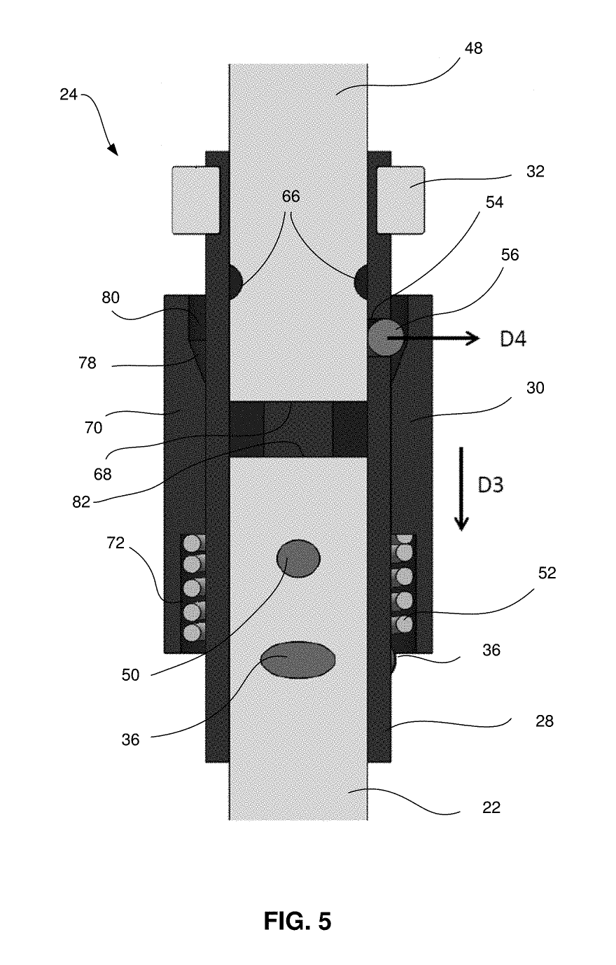

Turning to FIG. 5, the movable sleeve 30 has been moved in the direction of the arrow D3 to the unlock position. The spring 52 is compressed and will move the movable sleeve 30 back to the lock position if not held in the unlock position. In the unlock position, a pulling motion on the replaceable head 48 may cause the ball bearings 56 to move in the direction D4 from the curved circumferential channel 66 in an outward direction in the openings 54 until the ball bearings 56 are clear of the circumferential channel 66. The ball bearings move partially into the unlock section 80 of the unlock/lock recess 76 while being partially contained within the openings 54. The replaceable head 48 may be moved out of the coupler 24 in the unlock position. The illustration of FIG. 5 shows the end 68 moved away from the end surface 82 of the elongated body 22 in a partially removed position. The ball bearings 56 no longer prevent removal of the replaceable head 48 as a result of which the replaceable head 48 may be completely removed from the coupler 24.

FIG. 5 also shows the positions of the components during insertion of a replaceable head 48 into the coupler 24. The movable sleeve 30 is moved to a position to permit the ball bearings 56 to move into the unlock section 80. The ball bearings 56 are pushed in the direction D4 by the end 68 of the replaceable head 48 to permit the replaceable head 48 to be inserted into the coupler. After the replaceable head 48 has been inserted with the circumferential channel 66 at the openings 54, such as by inserting until the end 68 is against the end of the elongated member 22, the movable sleeve 30 is released. The ramp section 78 on the inside of the movable sleeve 30 engages the ball bearings 56 and press the ball bearings 56 along the openings 54 and into the circumferential channel 66 in the direction D2 shown in FIG. 4. As the movable sleeve 30 reaches the position bearing against the retaining collar 32, the replaceable head 48 is secured in the coupler 24.

The ramp section 78 may include a slanted, ramped or pitched surface that transitions the interior diameter of the movable sleeve 30 from a first diameter defined by the thick portion 70 to a second diameter that is greater than the first diameter in the unlock section 80. That is, the interior diameter of the movable sleeve 30 is larger in the unlock section 80 than the interior diameter of the movable sleeve 30 in the main portion thick portion 70. In other embodiments, the change in diameters can be abrupt by omitting or reducing the slanted, ramped, or pitched surface. In other embodiments, a curved surface can be used to transition from the thick portion 70 to the unlock section 80.

The internal recess 72 in the movable sleeve 30 may secure the spring 52 to the movable sleeve 30. The spring 52 can instead or additionally be connected to the movable sleeve 30 by one or more fasteners (e.g., glue, welding, or another fastener).

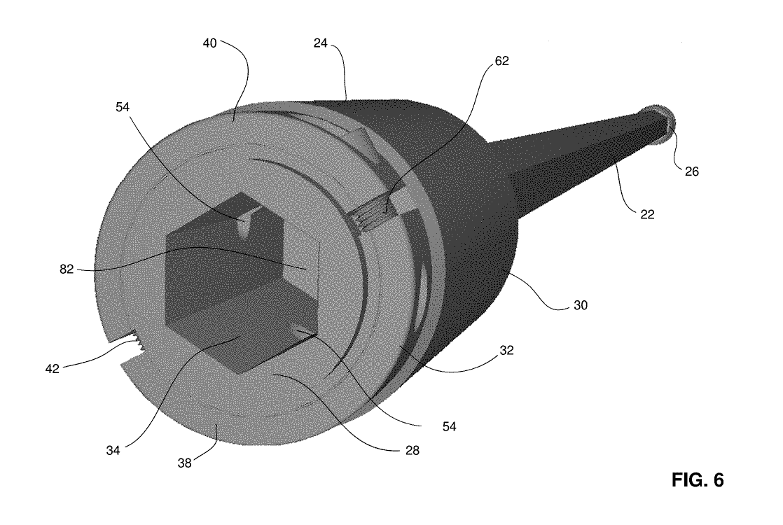

In FIG. 6, the coupler 24 includes the movable sleeve 30 and the retaining collar 32 about the broached sleeve 28. The broached sleeve 28 has an end opening or receiver 34 into which the mounting shaft 64 of a replaceable head 48 may be inserted. The bottom surface of the end opening 34 is formed by the end surface 82 of the elongated body 22. The interior surface of the broached sleeve 28 includes the openings 54 within which the ball bearings 56 are mounted. The openings 54 are shaped to permit the ball bearings 56 to engage the circumferential channel 66 in the replaceable head 48 but to prevent the ball bearings 56 from passing entirely through the openings 54 and into the interior of the end opening or receiver 34 when the replaceable head 48 is removed. The ball bearings 56 are not shown in this view but would ordinarily be visible extending inward from the interior walls of the receiver 34 when the movable sleeve 30 is in the locked position. The end opening or receiver 34 can be, for example, shaped as a hexagonal prism that is configured to accept a hexagonal-shaped replaceable head 48. In other embodiments, the opening 111 can be configured as another shape, such as a square or rectangular prism, an octagonal prism, a cylinder or another shape, as would be understood by one of ordinary skill in the art. In certain embodiments, the mounting shaft 64 of the replaceable heads 48 may have a corresponding shape as the end opening or receiver 34.

The first and second collar parts 38 and 40 are joined to one another by the screws 42 and 62 to engage the retaining collar 32 in the channel 58 of the broached sleeve 28 so that the flange 60 prevents the retaining collar 32 and movable sleeve 30 from being removed from the end of the broached sleeve 28. The threaded screws may be covered or anodized to avoid damage. For instance, the collar parts may be closely spaced when fastened to the broached sleeve 28 to avoid exposing the threads to damage. Other attachment means may be provided for securing the retaining collar 32 to the coupler 24 as is known.

In FIG. 7, the end opening or receiver 34 is of a hexagonal shape. Three openings 54 for the ball bearings 56 are provided in the sidewalls of the end opening or receiver 34, each at a corner of the hexagonal opening and evenly spaced about the hexagonal opening. The ball bearings 56 engage at the corners of the hexagonal mounting shaft 64 of the replaceable head 48, for secure engagement of the head in the coupler 24. The end surface 82 of the elongated member may be seen at the bottom of the end opening or receiver 34 and the movable sleeve 30 can be seen at the gaps between the two parts of the retaining collar 32.

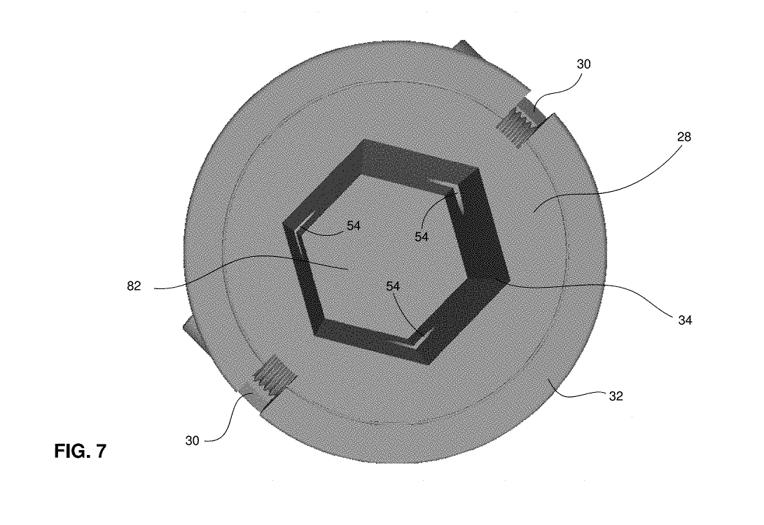

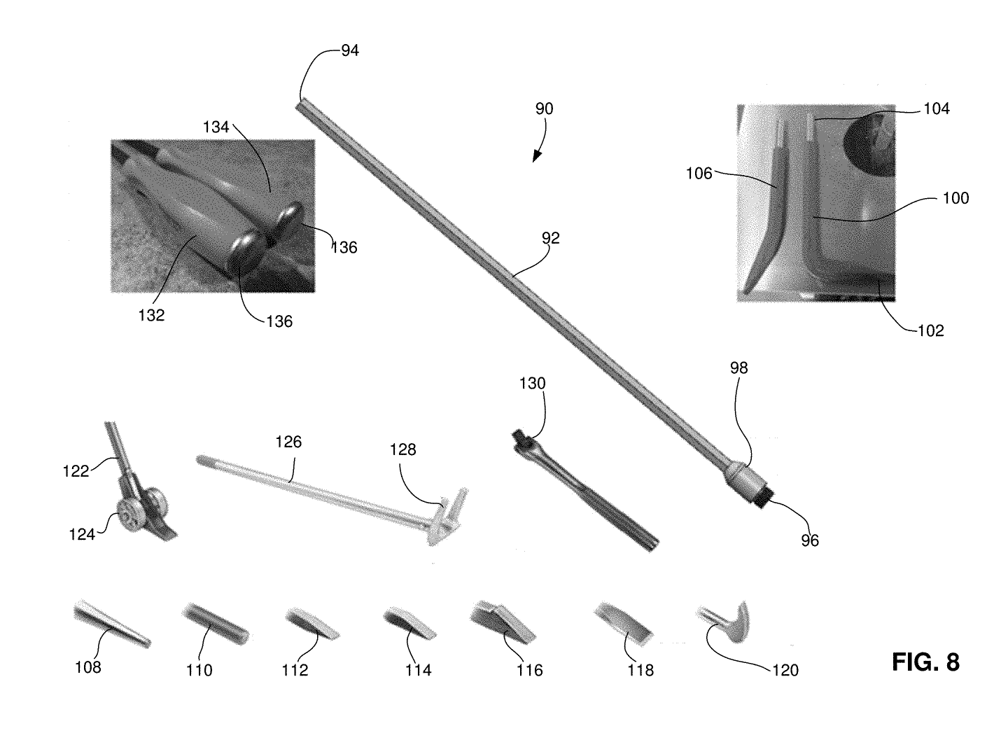

FIG. 8 shows another embodiment of a pry bar 90 having an elongated body 92 with a handle or striking end 94 and a coupler 96 at the other end. The coupler 96 may include a protective sleeve or boot 98 over the coupler 96. The protective sleeve or boot 98 may protect the coupler 96 from damage or from inadvertent release of the replaceable head. The pry bar 90 of this embodiment or of any embodiment may be provided with a system of attachments, components and accessories. As many or as few attachments, components and accessories as desired may be provided as the pry bar or pry bar system. A right angle replaceable head 100 has a flat or blade end 102 at a right angle to a mounting shaft 104. The mounting shaft 104 may be cylindrical or hexagonal and is shaped and configured to be received into the coupler of the pry bar embodiment for which it is provided. A 20 degree replaceable head 106 may be inserted into the pry bar in place of the right angle head 100 as desired by the user. The 20 degree head 106 includes a flat blade at a shallow angle, which may be useful for some applications. Replaceable heads with any angle desired may be provided for the pry bar system.

The working end of the replaceable head may be of any configuration desired. In certain examples, the replaceable head may be provided with a pointed working end 108, a rounded working end 110, a wedge working end 112, a pinch or bladed working end 114, a heeled pinch working end 116, a chisel or other sharpened working end 118, or a rocking or rocker working end 120. Any of these may be provided as straight, right angled, or any other angle desired and are configured for mounting in the coupler of the pry bar. Specialty heads maybe provided as well. For example, a 2-wheel lift 122 may include wheels 124 for rolling across a surface and a bladed working end at an angle for lifting flooring material or the like. Another optional head is a pallet buster 126 with a working end 128 shaped to breaking apart pallets or other objects. An extended handle is shown in the illustration, which handle may be replaced by a mounting shaft for mounting the pallet buster 126 in the coupler of the pry bar. Another example of a replaceable head that may be provided is a breaker bar head 130. The breaker bar head 130 may include a fixed or hinge-mounted drive square that is configured to fit into a socket having a correspondingly sized drive socket and configured to fit onto a bolt head, for example. The handle on the illustrated breaker bar 130 is replaced by a mounting shaft of a replaceable head so that the pry bar forms an extended handle for the breaker bar 130.

The pry bar system has so far been described as having replaceable heads 100-130 for use with the elongated body 92. The handle or striking end 94 of the elongated body 92 may be provided in different configurations or with interchangeable components as well. For example, large grip handle 132 and a small grip handle 134 depending on the comfort of the user, for example. Each grip handle 132 and 134 may include a striking surface 136. The grip handles 132 and 134 may be mounted onto the elongated body 92 or removed as desired.

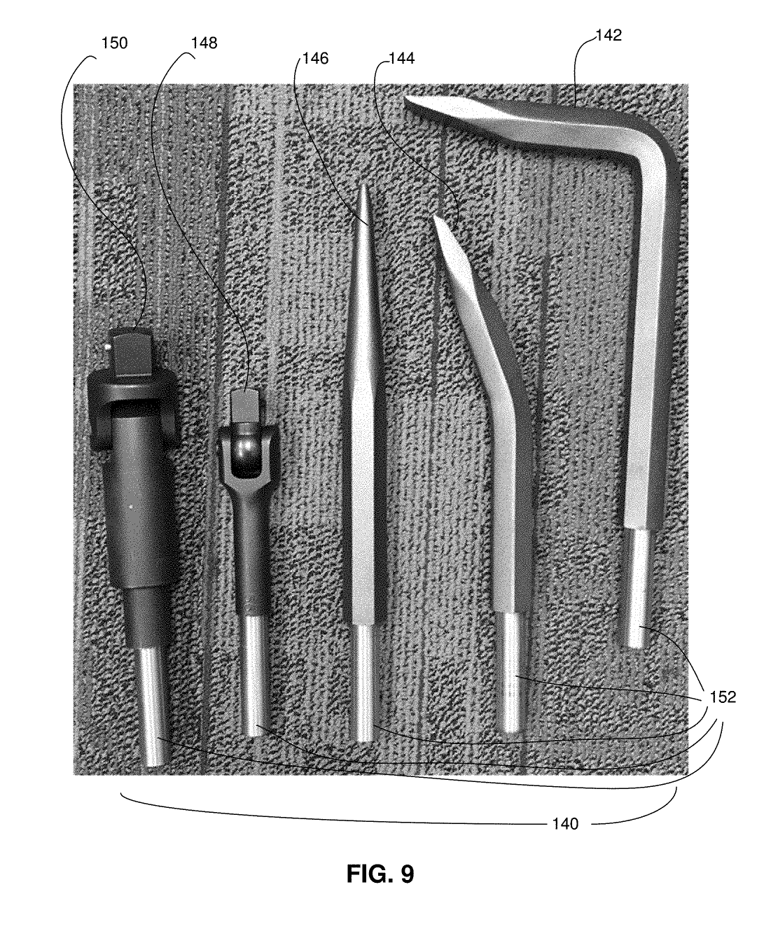

In FIG. 9 is shown a set 140 of replaceable heads for use with a pry bar. The set 140 includes a right angle head 142, a shallow angle head 144, a pointed head 146, a small square driver head 148 and a large square driver head 150. The square driver heads 148 and 150 may be used with drive sockets for turning bolts or the like using the pry bar for additional leverage. Each replaceable head 142-150 of the set 142 includes a cylindrical mounting shaft 152 for mounting in the coupler. The cylindrical mounting shafts 152 may be provided for certain embodiments of the coupler but other shapes of mounting shafts may be provided for other embodiments of the mounting assembly. For example, the cylindrical mounting shafts 152 may be replaced by hexagonal mounting shafts for use in a coupler 24 as shown in FIGS. 6 and 7. Other shapes of mounting shafts or replaceable heads may be provided.

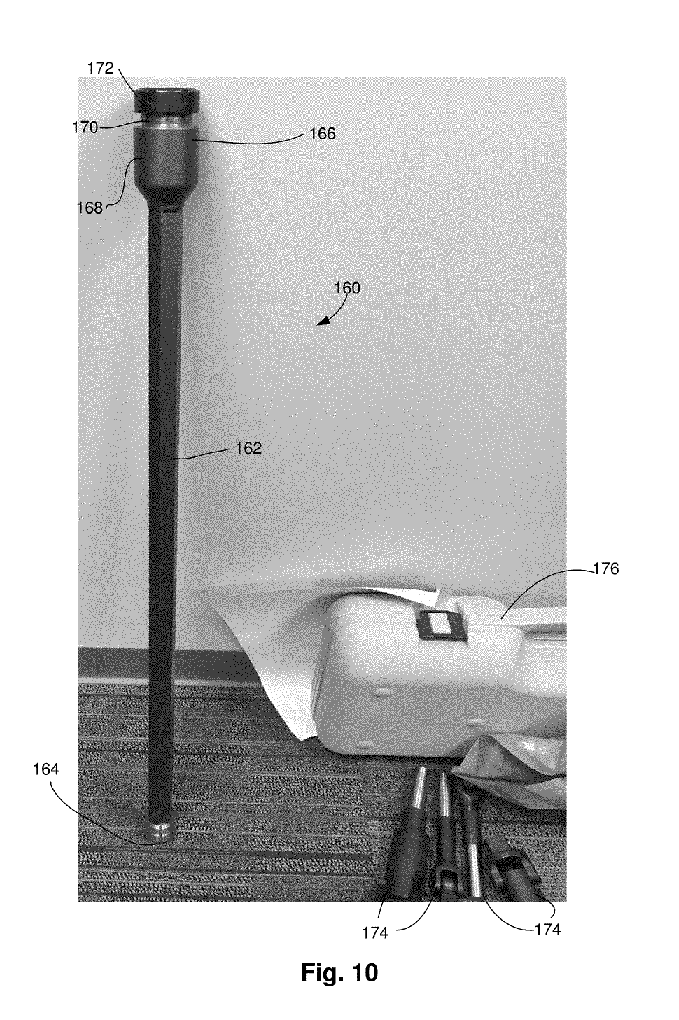

A further embodiment of the pry bar 160 is shown in FIG. 10. The pry bar 160 has an elongated body 162 on one end of which is a handle or striking face 164 and on the other end of which is a coupler 166. The coupler 166 includes a cylindrical body 168 on the end of the elongated body 162, a threaded portion 170 at the end of the cylindrical body 168 and a threaded collar 172. An assortment of replaceable heads 174 is provided for the pry bar 160, along with a case 176 in which to store and transport the replaceable heads 174.

FIG. 11 shows the coupler 166 of the pry bar 160 of FIG. 10. The coupler 166 includes a collet or collet sleeve 178 that is provided with radial kerf cuts that permit the collet 178 to contract and expand. The collet 178 provides a radially movable member for locking the replaceable head in the coupler. At least one of the cylindrical body 168, the collet 178 and the threaded collar includes a taper to selectively compress the collet 178 in a radial direction as the threaded collar 172 is rotated in a first direction and to permit expansion of the collet 178 in a radial direction as the threaded collar is rotated in a section direction. The threaded collar 172 includes an arrangement of notches 180 for receiving a tab of a collet chuck spanner wrench for tightening and loosening the threaded collar 172. The coupler 166 is configured for receiving cylindrical mounting portions of the removable heads. The threads may be anodized, or covered for protection in some embodiments.

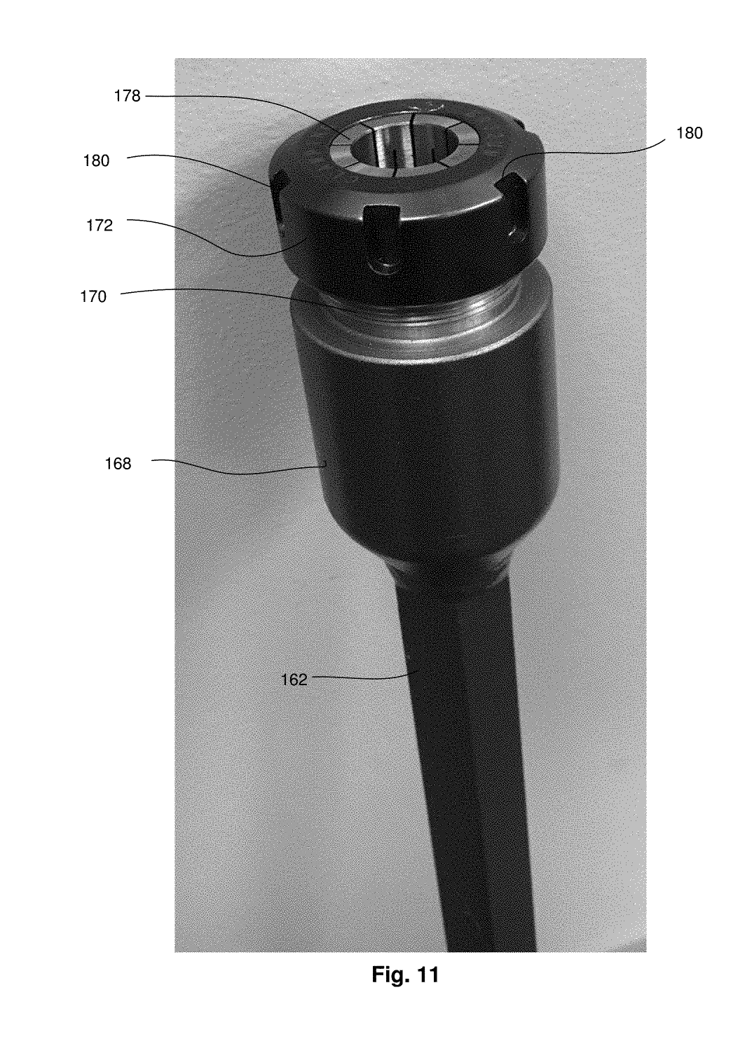

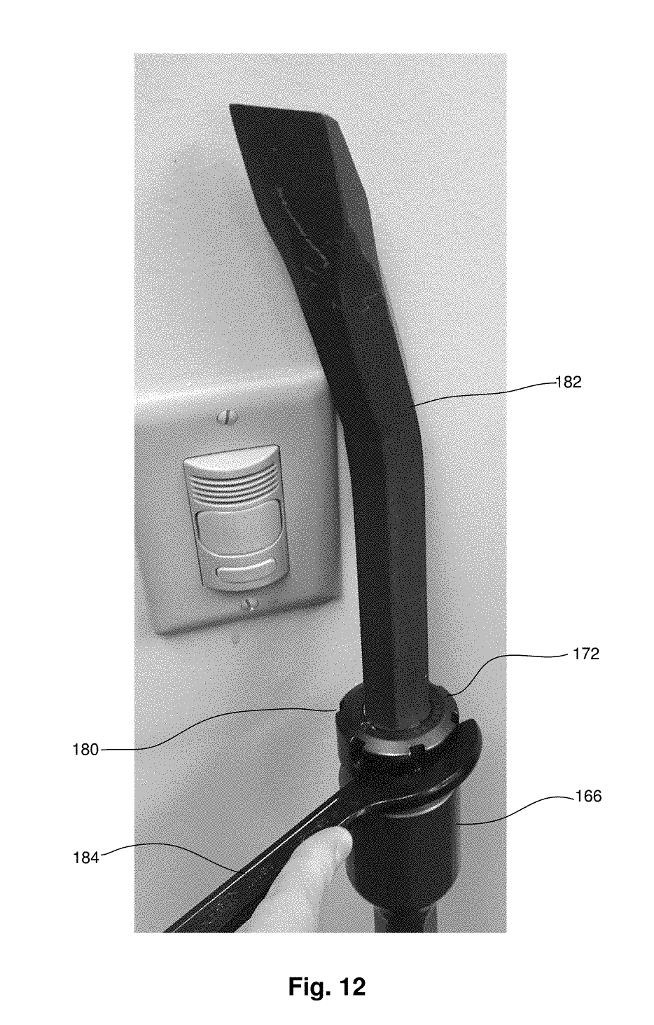

FIG. 12 shows the coupler 166 with a removable head 182 inserted into the collet 178. A collet chuck spanner wrench 184 is engaged in one of the notches 180 to rotate the threaded collar 172 for locking and unlocking the removable head 182.

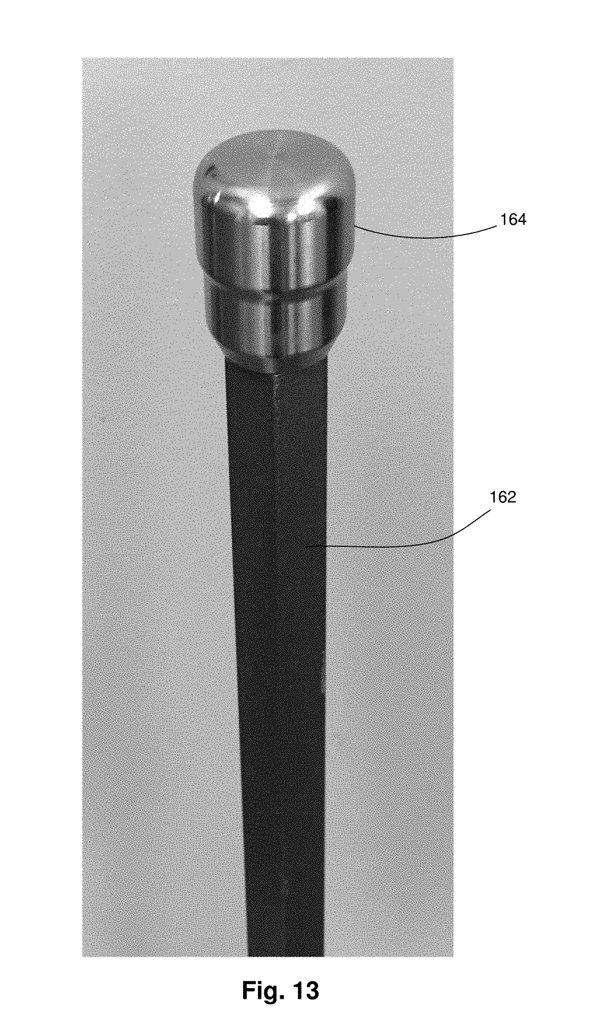

FIG. 13 shows the handle or striking surface 164 on the elongated body 162. The handle or striking surface 164 has a stepped configuration to provide a grip by which the pry bar 160 may be removed if stuck. The end may be struck with a hammer or other object to apply force along the pry bar 160.

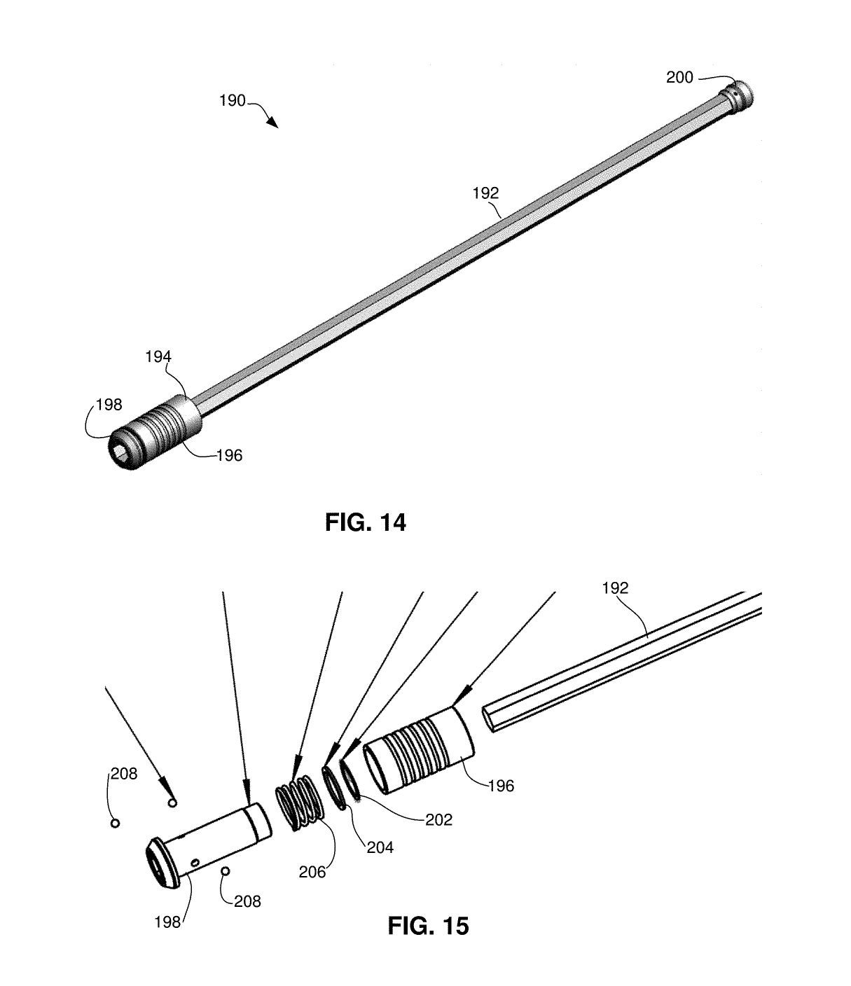

In a third embodiment as shown in FIG. 14, a pry bar 190 includes an elongated body 192 of a hexagonal shape. A coupler 194 includes a movable sleeve 196 on a broached sleeve 198. At the opposite end of the body 192 is a handle and striking member 200.

FIG. 15 shows the coupler 194 in exploded view. The movable sleeve 196 is removed to reveal a retainer ring 202, a washer 204, a coil spring 206, and ball bearings 208. The broached sleeve 198 includes a built in retainer collar.

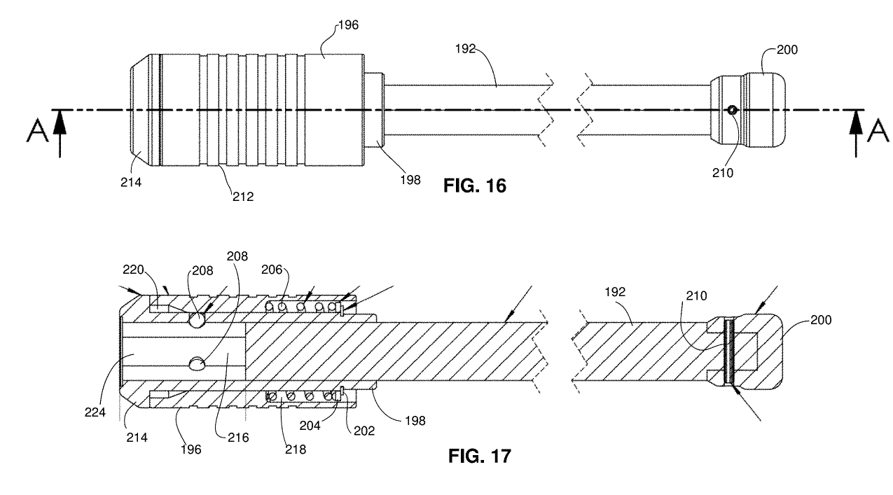

Turning to FIG. 16, the elongated body 192 has the handle and striking member 200 attached with a pin 210. The coupler 194 includes the movable sleeve 196 with ridges 212 to enhance the grip on the sleeve by a user. The broached sleeve 198 extends from the movable sleeve 196 toward the handle 200 when in the locked position. The broached sleeve 198 includes a retaining collar portion 214 to keep the movable sleeve 196 from being pushed off by the spring.

FIG. 17 shows the pin 210 extending through the elongated body 192 to hold the handle 200 on the pry bar. The elongated body 192 extends into an interior passage 216 of the broached sleeve 198. In certain embodiments, the receiver opening 224 formed by the portion of the interior passage 216 remaining after insertion of the elongated body 192 is approximately 2.5 inches in length. A head inserted into the receiver opening 224 may seat against the end of the elongated body 192 so that axial forces during use of the pry bar are transmitted through the head and directly to the elongated body 192. The end of the elongate body 192 in the receiver opening 224 also defines the distance from the end of the head to where the ball bearings 208 may engage into the channel on the head. The spring 206 is on the broached sleeve 198 and is held there by the washer 204 and the retainer ring 202. The spring 206 is in an internal recess 218 in the movable sleeve 196. The ball bearings 208 are mounted in openings in the broached sleeve 198. The openings in which the ball bearings 208 are mounted may be shaped or include retainers to keep the ball bearings 208 in the openings when the head is not in the receiver opening 224. An unlock recess 220 inside the end of the movable sleeve 196 permits the ball bearings 208 to move to an unlock position.

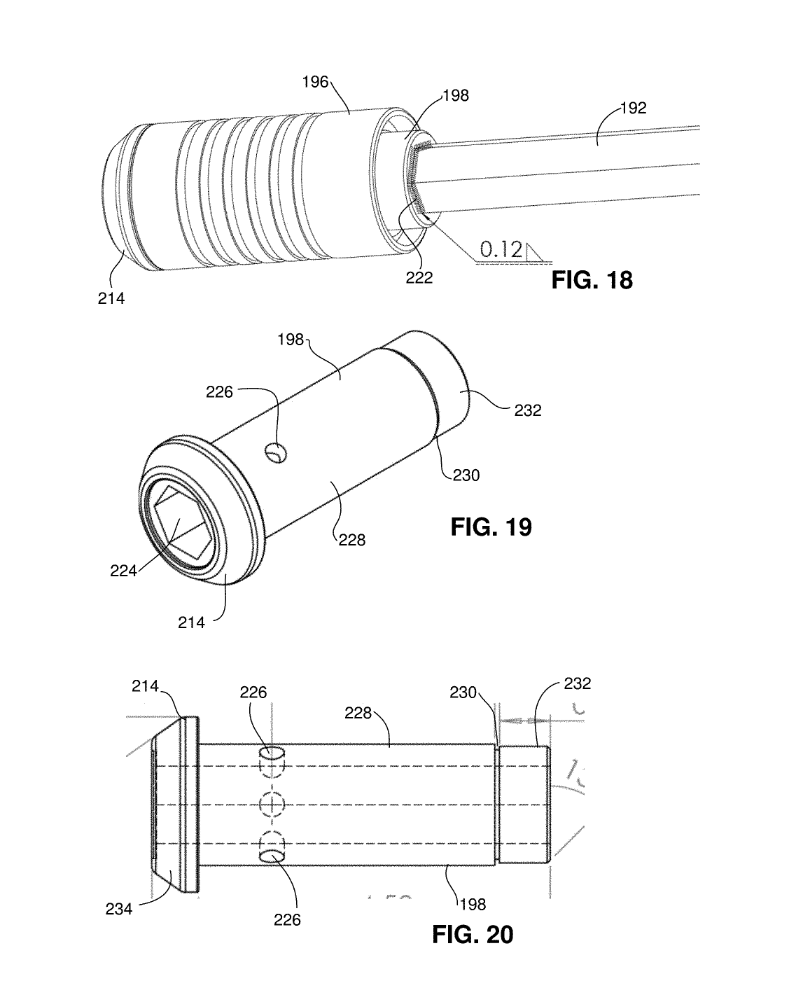

In FIG. 18 the broached sleeve 198 is inserted over the end of the elongated body 192 and is secured in place by welds 222. Other attachments of the broached sleeve 198 to the elongated body 192 may be provided as well.

FIG. 19 shows the broached sleeve 198 and the retaining collar portion 214 that is formed in one piece with the broached sleeve 198. A receiver opening 224 of a hexagonal shape opens at the end of the broached sleeve 198. An opening 226 for a ball bearing 208 is provided in a cylindrical portion 228. The end of the cylindrical portion 228 includes a groove 230 and an end step 232 of a smaller diameter than the cylindrical portion 228.

In FIG. 20, the broached sleeve 198 includes three openings 226 spaced evenly around the sleeve 198 to receive three ball bearings 208. The end step 232 is of a slightly smaller outside diameter than the cylindrical portion 228. The retaining collar portion 214 includes a beveled forward surface 234 that deflects blows to the coupler 194, for example.

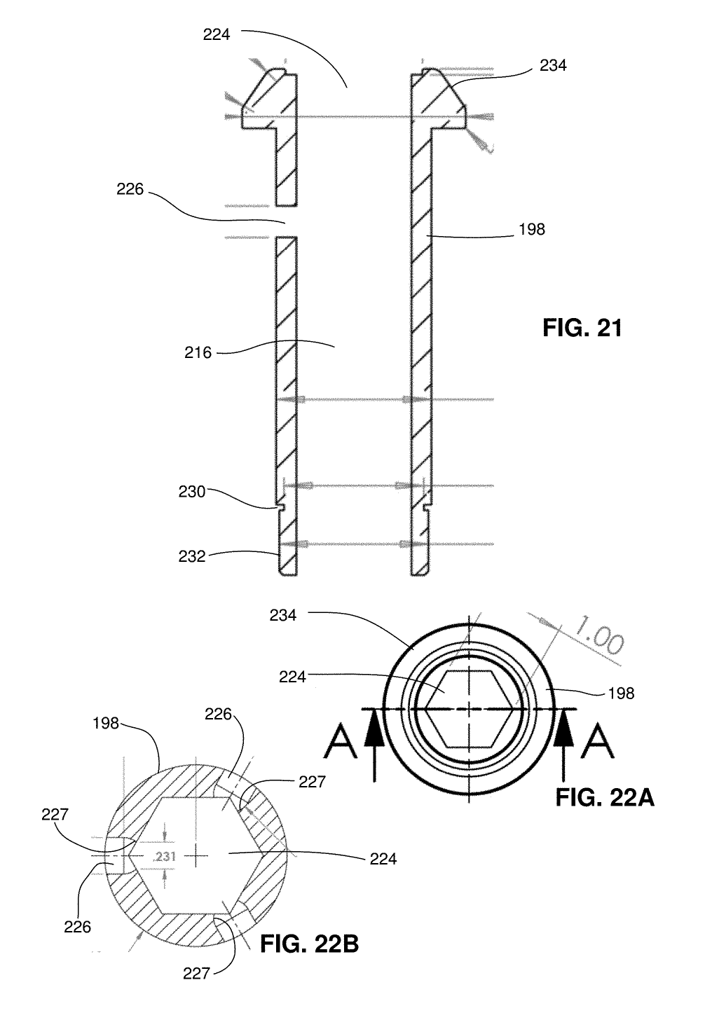

In FIG. 21, the broached sleeve 198 includes a constant cross section internal passageway 216 into which the elongated body 192 and the heads are inserted. A change in diameter or shape or additional structure may be provided, for example, as a reference for insertion of the elongated body 192 into the passage 216 during assembly. In FIG. 22A, the receiver opening 224 is of hexagonal shape and is of the same shape and size as the internal passageway 216. The beveled forward deflector surface 234 surrounds the receiver opening 224 and protects the broached sleeve 198 and the coupler 194. In FIG. 22B, a cross sectional view of the broached sleeve 198 at the openings 226 shows a narrowing or constriction 227 at the inner end of the openings 226. In certain embodiments, the narrowing or constriction 227 is an inwardly curved surface at a lower end of the openings 226 which prevents the ball bearings 208 from falling into the receiver opening 224 when the head is removed. Other shapes of narrowings or constrictions are also possible.

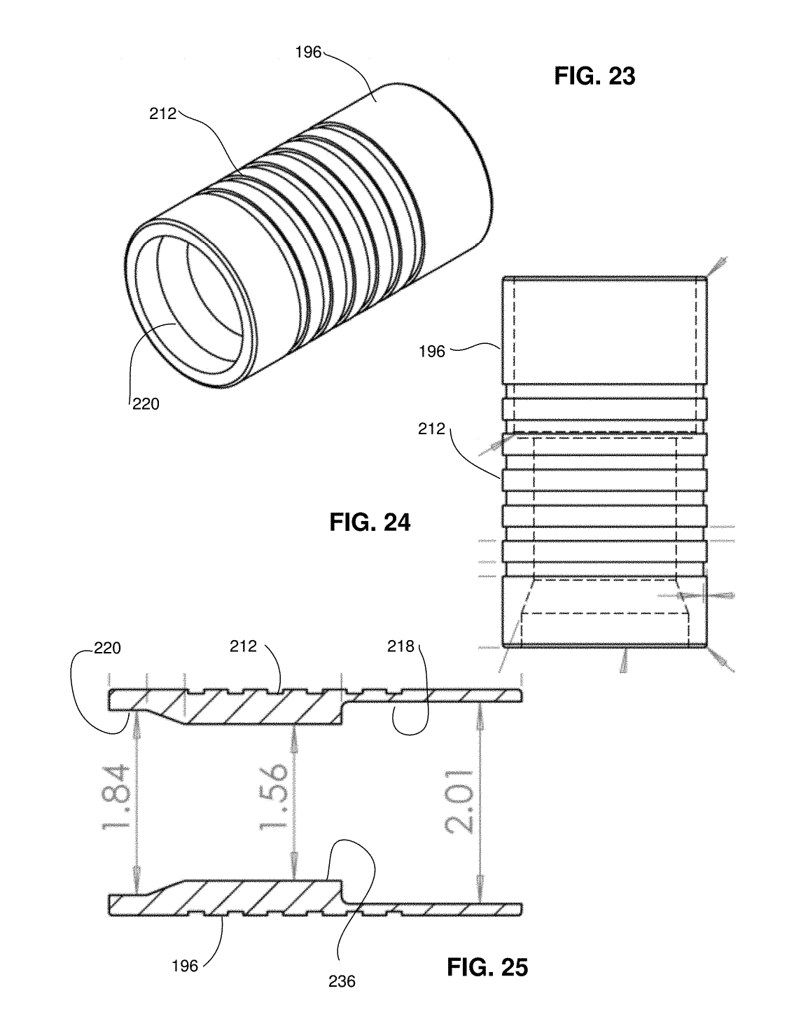

Turning to FIG. 23, the movable sleeve 196 of a hollow cylindrical shape with six grooves in the middle of the outer surface and slightly toward the forward end to form the ridges 212. The unlock recess 220 is inside the forward end of the movable sleeve 196. FIG. 24 shows that the movable sleeve 196 has an overall constant outside diameter with the ridges 212 formed by grooves formed into the outside surface. The ridges are closer to the forward end than to the back end, although this can be different. FIG. 25 shows the changes in internal diameter at the internal recess 218 and unlock recess 220. A thick portion 236 has an inside diameter to fit snuggly on the broached sleeve.

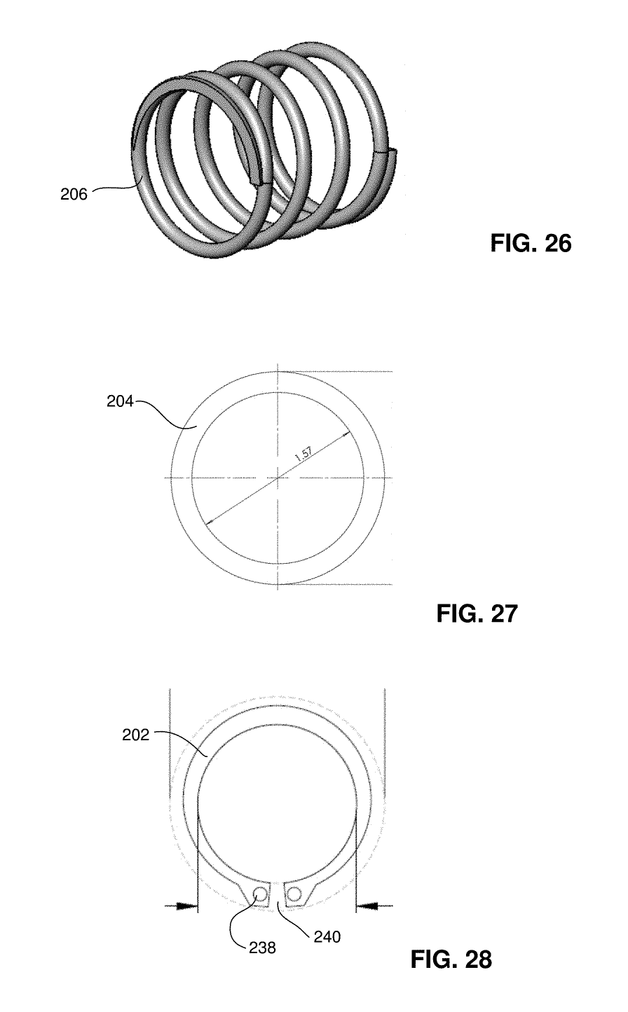

FIG. 26 is the coil spring 206 that fits onto the broached sleeve 198 and within the internal recess 218 of the movable sleeve 196 to bias the movable sleeve toward the locked position. FIG. 27 shows the washer 204 that has an internal diameter to fit onto the cylindrical portion 228 of the broached sleeve 198 so as to hold the spring 206 in place. FIG. 28 is the retainer ring 202 that has an internal diameter to fit into the groove 230 on the broached sleeve 198. The retainer ring 202 has release openings 238 on either side of a split 240 by which the retainer ring 202 may be opened for installation over the end step 232 of the broached sleeve 198 and into the groove 230. The release openings 238 may also be used for disassembly of the coupler as desired.

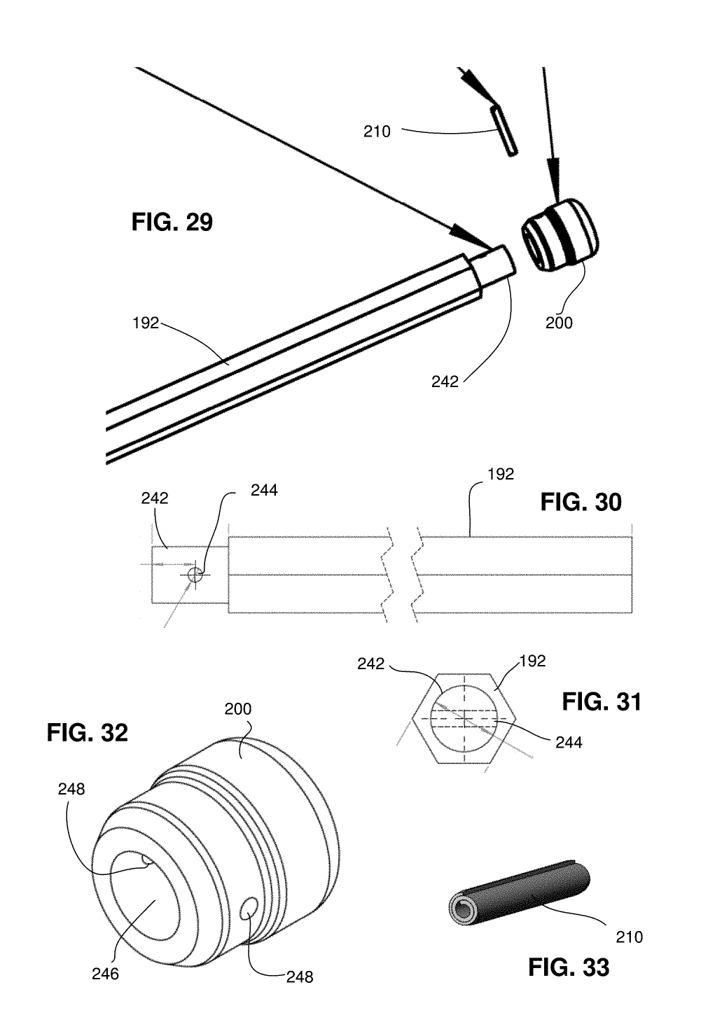

The handle and striking member 200 is shown in FIG. 29. The pin 210 by which the handle 200 is attached to the elongated body 192 is shown. The elongated body 192 is formed or shaped with a cylindrical end portion 242. In FIG. 30, the elongated body 192 has the cylindrical end portion 242 of reduced diameter. A bore 244 extends through the cylindrical end portion 242. In FIG. 31, the bore 244 extends through the cylindrical end portion 242.

FIG. 32 shows the handle and striking member 200 that prevents the pry bar from slipping from a user's hands and on which the pry bar may be struck by a hammer or other striking tool. The handle 200 has a contoured outer surface to enhance the grip. The handle 200 includes an opening 246 that is sized and shaped to fit onto the cylindrical end portion 242 and a bore 248 that is aligned with the bore 244. The pin 210 that is inserted into the aligned bores is shown in FIG. 33. The pin 210 of the illustrated embodiment is formed of a coil of flat metal to form a spring dowel or spiral pin. Other pins or fasteners are possible.

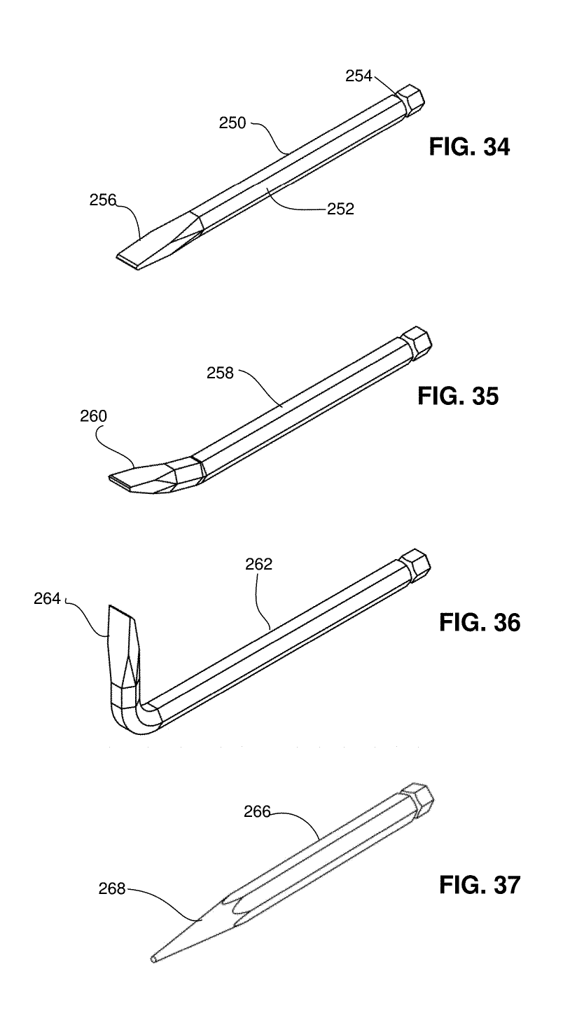

FIG. 34 shows a head 250 that may be inserted into and locked in the coupler. The head 250 includes a shaft 252 of a hexagonal shape that is sized and shaped to fit into the receiver opening of the coupler. A groove 254 is formed into the shaft 252 by which the head 250 is locked into the coupler. The groove 254 receives the ball bearings 208 in the locked position. A working end 256 is provided as a straight chisel end.

FIG. 35 shows a head 258 that also has a shaft and groove but has an angled chisel end 260 as the working end. FIG. 36 is a head 262 that includes a right angle working end 264 formed as a chisel formed at a right angle to the shaft. FIG. 37 is a head 266 in which the working end is a point 268. Each of the heads 250, 258, 262 and 266 has the same size and shape shaft 252 and the same groove 254 and can be interchangeable used in the coupler on the pry bar 190.

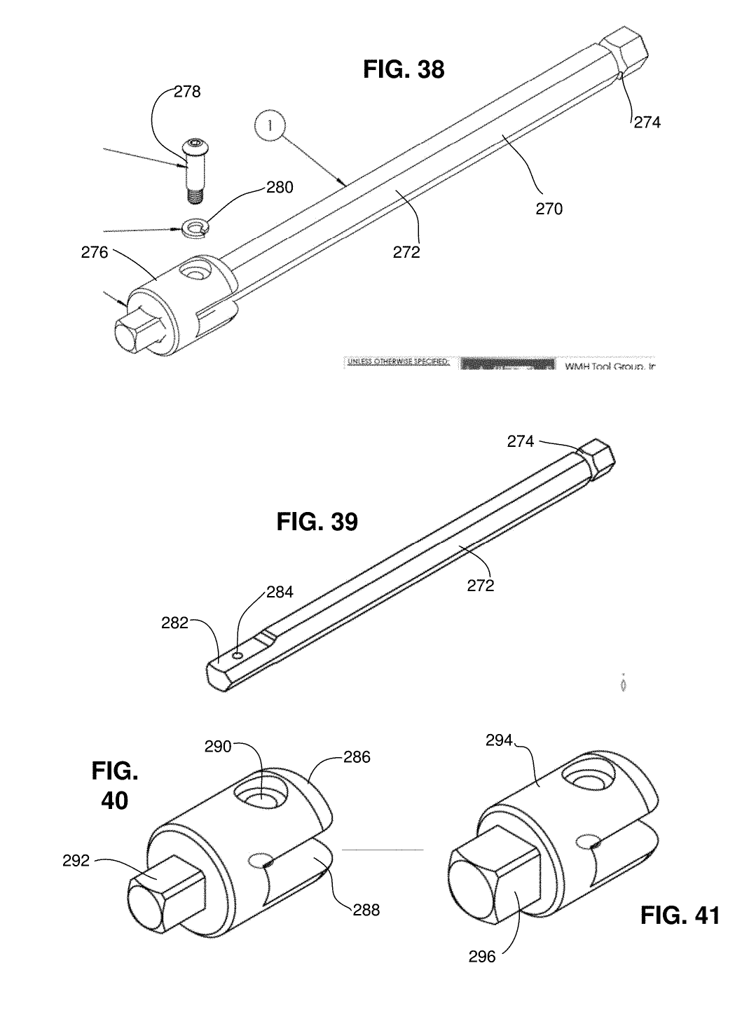

FIG. 38 shows a driver head 270 that has a shaft 272 and a groove 274 like other heads. A driver block 276 is pivotally mounted on the shaft 272 using a pair of screws 278 (only one of which is shown) that may each include a lock washer 280. FIG. 39 shows that the shaft 272 has flats 282 formed on both sides at an end and a threaded bore 284 formed in the flats 282. The screws 278 are fastened into the threaded bore 284 In FIG. 40, a driver block 286 has a slot 288 that fits onto the flats 282 and an opening 290 in each side that receives the screws 278. A small driver 292 is provided for connection to a socket, socket extension or other tool. FIG. 41 shows a driver block 294 having a large driver 296 for larger sockets and tools. The drivers may be of standard driver sizes.

With reference to one or more of the above-described embodiments, the pry bar embodiments shown include tool-less head locking and a tool-operated head locking embodiments. In the tool-less head locking method, in the locked position, the spring 52 biases the movable sleeve 30 towards (and against) the retaining collar 32 in the direction D1. The spring 52 generates a biasing force in the direction D1. When transitioned from the unlocked position to the locked position, the movable sleeve 30 moves in the direction D1 and causes the ball bearings 56 to move in the direction D2 to engage the recessed portion 66 of the attachment head or replaceable head 48. When the movable sleeve 30 moves into the unlocked position, the movable sleeve 30 travels along the broached sleeve 28 in the direction D3. This movement causes the spring 52 to compress. For example, the user of the pry bar 20 can force the movable sleeve 30 to move in the direction D3 and against the biasing force of the spring 52 to cause the spring 52 to compress. With this action, the ball bearings 56 are allowed to enter the recessed portion or unlock section 80 of the movable sleeve 30. With the ball bearings 56 in the recessed portion or unlock section 80, the attachment head or replaceable head 48 can be inserted into the opening 34 of the broached sleeve 28 in the direction D3 (or withdrawn from the opening 34 in the direction opposite to direction D3). This movement will force the ball bearings 56 into their respective openings 54 and into the recessed portion or unlock section 80.

When the attachment head or replaceable head 48 is fully inserted into the coupler 24, the force positioning the movable sleeve 30 in the unlocked position can be removed. The removal of this force causes the movable sleeve 30 to move (in the direction D1) into the locked position due to the biasing force of the spring 52. The movement of the movable sleeve 30 in the direction D1 causes the ball bearings 56 to travel in the direction D2 due to the change in interior diameter of the movable sleeve 30. As the movable sleeve 30 moves in the direction D1, the portion of the movable sleeve 30 located adjacent to the openings 54 of the broached sleeve 28 changes from the recessed portion or unlock section 80 to the thick portion 70 having a smaller interior diameter. Due to the smaller diameter, the ball bearings 56 are forced into the respective openings 54 and engage the recessed portion or circumferential channel 66 of the attachment head or replacement head 48. In the locked position, the ball bearings 56 are secured into the recessed portion 66 and secure the attachment head or replacement head 48 within the interior portion of the broached sleeve 28 to affix the attachment head or replacement head 48 to the pry bar 20.

The opposite operation is performed to remove the attachment head or replacement head 48 from the coupler 24. For example, the movable sleeve 30 is moved in the direction D3 to position the recessed portion or unlock section 80 of the movable sleeve 30 adjacent to the openings 54. This allows the ball bearings 56 to disengage (move in the direction D4) from the recessed portion or circumferential channel 66 of the attachment head 48 as the attached head 48 is removed (moved in the direction opposite of direction D3).

The movable sleeve 30 can move between a locked position and an unlocked position. A first end of the broached sleeve 28 is connected to a first end of an elongated body 22 of the pry bar 20. The second end of the elongated body 22 opposite the first end can include a striking surface 26. The striking surface and/or another striking surface may be provided at one or more other locations of the pry bar. The second end of the broached sleeve 28 opposite the first end of the broached sleeve 28 includes the opening, mouth, or other receiving port 34 that is configured to accept the pry bar attachment heads 48. The opening 34 is configured to accept the ends 68 of the attachment heads 48.

In certain embodiments, the movable sleeve 30 is biased into the locking position of the coupler 24. In the locking position, the movable sleeve 30 is biased towards the retaining collar 32. The movable sleeve 30 can be biased to contact the retaining collar 32.

In an exemplary embodiment, the pry bar 20 can include one or more hand grips and/or handles 132, 134. In an exemplary embodiment, the pry bar 20 or one or more components of the pry bar can be formed of, for example, hardened tool steel, but is not limited thereto. An example of the material is hardened 4140 steel.

In the tool-operated method, a locking collar 172 may be provided on the collet or chuck 166. The locking collar 172 may be rounded or provided with other shapes to avoid interfering with work or becoming damaged. The collar 172 may include a threaded ring that is tightened onto a tapered receiver 178 of the collet so as to apply clamping pressure onto the inserted extension of the head 182.

In an certain embodiments, the attachment heads may include an extension for insertion into the coupler. In certain examples, the extension is cylindrical or hexagonal extension and is approximately three inches in length and 0.745 inches in diameter, plus or minus manufacturing tolerances, but is not limited thereto.

An attachment head or replacement head can be configured for use with a socket, such as ¾ inch or 1 inch drive sockets or other dimensions. A paddle or other wide end tool may be provided as an attachment head or replaceable head for the pry bar. A kicker plate may be provided, such as on the interchangeable head or otherwise. Wheels may be provided on the head for moving the head along a surface such as along a floor during tile removal. A 2 inch to 3 inch head cylinder rod removal tool may be provided as an interchangeable head.

Larger and smaller versions of the pry bar and/or attachment heads or replaceable heads may be provided as needed. A smaller version of the pry bar 100 may be used for bearing work. A reversible head for use with sockets may be provided. A torque attachment may also be provided.

In certain embodiments, a plurality of heads may be provided for fastening into the collet or chuck. In certain embodiments, a spanner wrench is used to tighten and/or loosen the collet or chuck for attachment or removal of the heads. A standard wrench, such as a crescent wrench may be provided in certain embodiments. A standard size wrench is used for fastening or tightening in certain embodiments.

The pry bar replaces multiple pry bars, each with a different head. A hand grip or handle may be provided in certain embodiments, but may be eliminated in other embodiments. Examples of the pry bar, including the coupler, and interchangeable attachment heads are shown in the drawings.

### CONCLUSION

Although other modifications and changes may be suggested by those skilled in the art, it is the intention of the inventors to embody within the patent warranted hereon all changes and modifications as reasonably and properly come within the scope of their contribution to the art.

The aforementioned description of the specific embodiments will so fully reveal the general nature of the disclosure that others can, by applying knowledge within the skill of the art, readily modify and/or adapt for various applications such specific embodiments, without undue experimentation, and without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

We claim:

1. A pry bar, comprising:
a pry bar body having a first end and a second opposite end; and
a coupler at the first end of the pry bar body, the coupler being configured to:
receive a mounting end of a replaceable head in the coupler, the coupler being operable to selectively affix the mounting end of the replaceable head in the coupler for use of the replaceable head in the pry bar body, the coupler being operable to selectively release the replaceable head from the coupler for removal of the replaceable head from the pry bar body.

2. The pry bar as claimed in claim 1, further comprising:
the replaceable head having the mounting end within and fastened in the coupler, the replaceable head including a working end opposite the mounting end.

3. The pry bar as claimed in claim 2, wherein the mounting end of the replaceable head is a hexagonal prism shape, and
wherein the coupler defines a hexagonal receiver opening configured to receive the mounting end of the replaceable head.

4. The pry bar as claimed in claim 2, wherein the mounting end of the replaceable head is of a cylindrical shape; and
wherein the coupler defines a cylindrical receiver opening configured to receive the mounting end of the replaceable head.

5. The pry bar as claimed in claim 1, wherein the coupler includes a movable sleeve that is configured for movement between a locked position and an unlocked position, the movable sleeve being configured for fastening the mounting end of the replaceable head in the coupler when in the locked position and being configured for releasing the mounting end of the replaceable head from the coupler when in the unlocked position.

6. The pry bar as claimed in claim 5, wherein the movable sleeve is configured for sliding movement in an axial direction of the pry bar when moving between the locked position and the unlocked position.

7. The pry bar as claimed in claim 5, wherein the coupler includes a spring operatively connected to the movable sleeve and configured for urging the movable sleeve toward the locked position.

8. The pry bar as claimed in claim 1, wherein the coupler includes at least one locking member configured to move radially relative to an axis of the pry bar between a locked radial position and an unlocked radial position, the at least one locking member selectively securing the replaceable head in the coupler in the locked radial position and selectively unsecuring the replaceable head in the coupler in the unlocked radial position.

9. The pry bar as claimed in claim 8, wherein the coupler includes
a broached sleeve defining a receiver opening configured for receiving the end of the replaceable head, the broached sleeve defining at least one radially extending opening within which the at least one locking member moves between the locked radial position and the unlocked radial position.

10. The pry bar as claimed in claim 9, wherein the at least one radially extending opening comprises a plurality of radially extending openings in the broached sleeve, and
wherein the at least one locking member comprises a plurality of locking members in respective ones of the plurality of radially extending openings.

11. The pry bar as claimed in claim 8, wherein the coupler includes a movable sleeve mounted for movement between a locked position and an unlocked position, the movable sleeve including a section that engages the at least one locking member as the movable sleeve is moved from the unlocked position to the locked position to move the at least one locking member from the unlocked radial position to the locked radial position.

12. The pry bar as claimed in claim 8, further comprising:
a replaceable head having a mounting end configured for mounting in the coupler, the mounting end of the replaceable head defining a recess or channel configured to receive the at least one locking member when the at least one locking member is in the locked radial position.

13. The pry bar as claimed in claim 10, wherein the mounting end of the replaceable head is a hexagonal prism shape, the recess or channel being formed into corners of the hexagonal prism shape.

14. The pry bar as claimed in claim 8, wherein the at least one locking member includes a collet sleeve; and further comprising:
a threaded collar mounted on the coupler and operable to selectively compress the collet sleeve onto a mounting end of the replaceable head for locking the replaceable head in the coupler.

15. A method of replacing a working head on a pry bar, comprising:
operating a coupler to unlock a first replaceable head from an elongated body of the pry bar;
removing a mounting end of the first replaceable head from the coupler;
inserting a mounting end of a second replaceable head into a receiver opening of the coupler; and
operating the coupler to lock the mounting end of the second replaceable head to the elongated body of the pry bar.

16. The method as claimed in claim 15, wherein the operating to unlock includes moving a movable sleeve in a first axial direction of the elongated body of the pry bar to release radially movable locking members from engagement with the first replaceable head; and
wherein the operating to lock include moving the movable sleeve in a second axial direction of the elongated body of the pry bar to move radially movable locking member into engagement with the second replaceable head.

17. The method as claimed in claim 15, wherein the operating to unlock includes rotating a collar on the coupler in a first direction to release a collet sleeve from the mounting end of the first replaceable head; and
wherein the operating to lock includes rotating the collar on the coupler in a second direction to engage the collet sleeve on the mounting end of the second replaceable head.

18. A pry bar, comprising:
an elongated pry bar body having a first end and a second end opposite the first end;
a coupler at the first end of the elongated pry bar body, the coupler including:
a broached sleeve mounted on the first end of the elongated pry bar body, the broached sleeve defining a receiver opening at an end of the broached sleeve opposite the elongated pry bar body, the broached sleeve defining a plurality of radial openings through the broached sleeve, the radial openings extending between an outer surface of the broached sleeve and the receiver opening within the broached sleeve;
a plurality of movable locking elements in respective ones of the plurality of radial openings, the movable locking elements being movable within the radial openings between a locked radial position and an unlocked radial position;
a movable sleeve mounted coaxially on the broached sleeve, the movable sleeve including a shaped inside surface selectively engaged with the plurality of movable locking elements, the movable sleeve being configured for movement in an axial direction of the elongated body between a locked position and an unlocked position, the shaped inside surface moving the plurality of movable locking elements from the unlocked radial position to the locked radial position when the movable sleeve is moved from the unlocked position to the locked position; and
a spring operatively connected to the movable sleeve and biasing the movable sleeve to the locked position.

19. The pry bar as claimed in claim 18, wherein the receiver opening of the broached sleeve is a hexagonal shaped opening having corners; and
wherein the plurality of movable locking elements extend into the receiver opening at the corners when in the locked radial position.

20. The pry bar as claimed in claim 18, further comprising:
a retaining collar mounted in a channel of the broached sleeve and disposed in a position to engage the movable sleeve when the movable sleeve is in the locked position.

21. A pry bar system, comprising:
an elongated pry bar body having a coupler at one end, the coupler being operable between a locked position and an unlocked position, the coupler defining a receiver opening; and
a set of replaceable heads, each of the replaceable heads in the set having a mounting end and a working end, the mounting end being shaped for mounting in the receiver opening of the coupler, the replaceable heads in the set being mountable in the coupler to provide a pry bar with a first working end of the respective replaceable head mounted in the coupler, the replaceable heads being replaceable in the coupler to provide a pry bar with a second working end of a different replaceable head mounted in the coupler, the first and second working ends being different from one another.
